(19) United States
(12) Patent Application Publication
(10) Pub. No.: US 2014/0168405 A1
(43) Pub. Date: Jun. 19, 2014

(54) SAMPLING ASSEMBLY, MICROSCOPE MODULE, AND MICROSCOPE APPARATUS

(71) Applicant: National Taiwan University, Taipei (TW)

(72) Inventors: Andrew Man Chung Wo, Taipei (TW); Cheng-Ming Lin, New Taipei City (TW); Shu-Sheng Lin, Taipei (TW); Chang-Yu Chen, Taichung City (TW); Tsun-Chao Chiang, Taipei (TW)

(73) Assignee: National Taiwan University, Taipei (TW)

(21) Appl. No.: 14/108,269

(22) Filed: Dec. 16, 2013

Related U.S. Application Data
(60) Provisional application No. 61/737,831, filed on Dec. 17, 2012.

(51) Int. Cl. G02B 21/34; G02B 21/36

(52) U.S. Cl. CPC G02B 21/34; G02B 21/365
USPC 348/80; 359/398; 359/385; 435/309.1

(57) ABSTRACT

A microscope apparatus is disclosed. The microscope apparatus comprises a microscope module and an image capture device. The microscope module comprises a housing, a lens element, a sampling assembly, and a light guide element. The lens element is mounted on the housing. The sampling assembly is accommodated in the housing. The light guide element is mounted in the sampling assembly. The sampling assembly is configured to sample a specimen and comprises a cover body and a base body received in the cover body. The cover body has a first top plate and a first anchoring structure connected to the top plate. The base body has a second opt plate and a second anchoring structure connected to the second top plate. The second top plate faces the first top plate to define a holding space for the specimen.

### CROSS-REFERENCE TO RELATED APPLICATION(S)

This application claims priority to U.S. Provisional Patent Application No. 61/737,831, filed on Dec. 17, 2012, the disclosure of which is hereby incorporated by reference in its entirety.

### BACKGROUND

1. Field of the Disclosure

The present disclosure relates to a microscope module and a microscope apparatus, and more particularly, to a microscope module and a microscope apparatus having a sampling assembly.

2. Description of the Related Art

A microscope cooperated with a slide glass or a cell counter is a traditional device for measuring cells and bio-specimen in basic biology, biomedical research, medical diagnostics and materials science. However, the mechanism of the microscope is usually complex and the equipment of it is hard to be carried. Moreover, a researcher should be received a professionally training to operate it, and it consumes long time to analyze measuring results.

For example, in order to measure dynamic sample of particles, e.g. spermatozoa, such as translation speed and the rotational speed of particles, the expert should place a drop of the sample in a cell counter, put the cell counter in the microscope, and manually count the number of cells in a certain area of the cell counter. Since the depth of the certain area is predefined, thus the volume of the counted cells can be calculated and the concentration of the counted cells can be obtained. The above-mention steps should be performed by the expert in a biological laboratory, therefore, that is quite inconvenient for human subjects.

Hence, there is a need for a portable device for measuring cells and bio-specimen that can improve sampling speed and simplify measuring process.

### SUMMARY

The present disclosure describes a sampling assembly, a microscope module, and a microscope apparatus comprising the microscope module and an image capture device. The sampling assembly may be applied to sample a specimen. The microscope module may be applied to provide a sampling image to the image capture device.

In an embodiment, the sampling assembly comprises a cover body and a base body received in the cover body. The cover body has a first top plate and a first anchoring structure connected to the first top plate. The base body has a second top plate and a second anchoring structure connected to the second top plate, wherein the second top plate faces the first top plate and a holding space for the specimen.

In an embodiment, the microscope module comprises a housing, a lens element, a sampling assembly, and a light guide element. The housing has a head plate, a lateral structure connected to the head plate, and a cavity between the head plate and the lateral structure, wherein the head plate has a first hole. The lens element is mounted on the first hole and aligned with the image capture device. The sampling assembly is accommodated in the cavity. The sampling assembly comprises a cover body and a base body received in the cover body. The first top plate of the cover body faces the lens element. The light guide element is connected to the sampling assembly.

In an embodiment, the microscope apparatus comprises a microscope module and an image capture device. The microscope module comprises a housing, a lens element, a sampling assembly, and a light guide element. The image capture device comprises a lens module, an image sensor, and a processing unit. The lens module is aligned with and cooperated with a lens element of the microscope module to obtain a sampling image. The image sensor is configured to capture the sampling image from the lens module and transform the sampling image into a sampling image signal. The processing unit is electrically connected to the image sensor and configured to perform an image process on the sampling image signal and generate an analysis data.

Overall, the present disclosure describes the microscope apparatus that could improve processing speed of sampling and detection of a specimen by using a sampling assembly. In addition, the structure of the sampling assembly could avoid unwanted contaminations.

The foregoing is a summary and shall not be construed to limit the scope of the claims. The operations and devices disclosed herein may be implemented in a number of ways, and such changes and modifications may be made without departing from this disclosure and its broader aspects. Other aspects, inventive features, and advantages, as defined solely by the claims, are described in the non-limiting detailed description set forth below.

### BRIEF DESCRIPTION OF THE DRAWINGS

FIG. 1A depicts a schematic diagram illustrating a microscope apparatus, in accordance with an example embodiment of the present disclosure.

FIG. 1B depicts a schematic diagram illustrating a sampling assembly, in accordance with an example embodiment of the present disclosure.

FIG. 2A depicts a top view of a base body of a sampling assembly, in accordance with an example embodiment of the present disclosure.

FIG. 2B depicts a section view of a base body of a sampling assembly, in accordance with an example embodiment of the present disclosure.

FIG. 2C depicts a bottom view of a cover body of a sampling assembly, in accordance with an example embodiment of the present disclosure.

FIG. 2D depicts a section view of a cover body of a sampling assembly, in accordance with an example embodiment of the present disclosure.

FIG. 3A depicts a top view of a base body of a sampling assembly, in accordance with an example embodiment of the present disclosure.

FIG. 3B depicts a section view of a base body of a sampling assembly, in accordance with an example embodiment of the present disclosure.

FIG. 3C depicts a bottom view of a cover body of a sampling assembly, in accordance with an example embodiment of the present disclosure.

FIG. 3D depicts a section view of a cover body of a sampling assembly, in accordance with an example embodiment of the present disclosure.

FIG. 4 depicts a schematic diagram illustrating a light guide element of a microscope module, in accordance with an example embodiment of the present disclosure.

FIG. 5 depicts schematic diagram illustrating a light guide element of a microscope module, in accordance with an example embodiment of the present disclosure.

### DETAILED DESCRIPTION OF EMBODIMENTS

For a more complete understanding of the present disclosure and its advantages, reference is now made to the following description taken in conjunction with the accompanying drawings, in which like reference numbers indicate like features. One of ordinary skill in the art will understand other varieties for implementing example embodiments, including those described herein. The drawings are not limited to specific scale and similar reference numbers are used for representing similar elements. As used in the disclosure and the appended claims, the terms “example embodiment,” “exemplary embodiment,” and “present embodiment” do not necessarily refer to a single embodiment, although it may, and various example embodiments may be readily combined and interchanged, without departing from the scope or spirit of the present disclosure. Furthermore, the terminology as used herein is for the purpose of describing example embodiments only and is not intended to be a limitation of the disclosure. In this respect, as used herein, the term “in” may include “in” and “on”, and the terms “a”, “an” and “the” may include singular and plural references. Furthermore, as used herein, the term “by” may also mean “from”, depending on the context. Furthermore, as used herein, the term “if” may also mean “when” or “upon”, depending on the context. Furthermore, as used herein, the words “and/or” may refer to and encompass any and all possible combinations of one or more of the associated listed items.

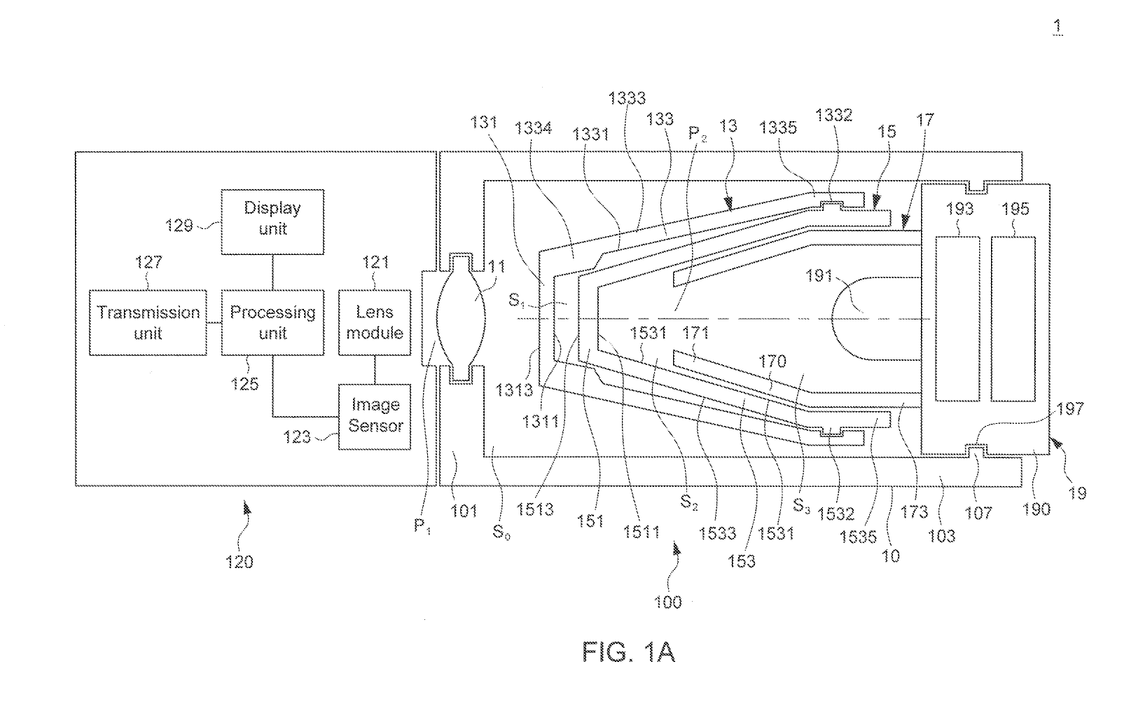

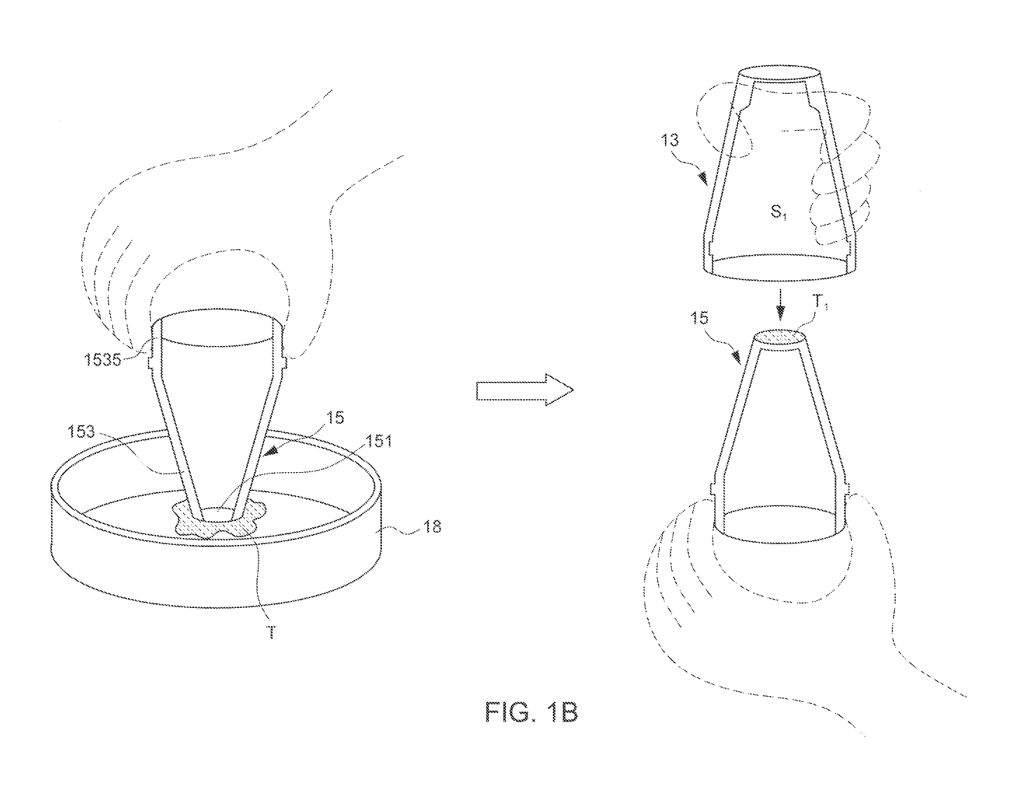

FIG. 1A depicts a schematic diagram illustrating a microscope apparatus, in accordance with an example embodiment of the present disclosure. The microscope apparatus 1 may comprise a microscope module 100 and an image capture device 120. In an embodiment, the microscope module 100 may be alternatively attachable or securable to the image capture device 120 via an adapter module between the microscope module 100 and the image capture device 120. In another embodiment, the microscope module 100 may be fixedly mounted or connected to the image capture device 120. The microscope module 100 could be applied to provide an enlarged sampling image to the image capture device 120. The image capture device 120 could capture the enlarged sampling image, transform the enlarged sampling image into a sampling image signal, analyze the sampling image signal to generate an analysis data, and output the analysis data.

In an embodiment, the image capture device 120 may be built in a portable, hand-held cellular phone, camera, or tablet computer. The image capture device 120 may comprise a lens module 121, an image sensor 123, a processing unit 125, a transmission unit 127, and a display unit 129. The image sensor 123 may be coupled to the lens module 121. The processing unit 125 may be electrically connected to the image sensor 123, the transmission unit 127, and the display unit 129. The lens module 121 could obtain an enlarged sampling image. The image sensor 123 could capture the enlarged sampling image from the lens module 121, and transform the enlarged sampling image into a sampling image signal. The processing unit 125 could be programmed to perform an image process on the sampling image signal, and generate an analysis data according to the sampling image signal. The transmission unit 127 could outputs the analysis data or the sampling image signal. The display unit 129 could show the sampling image or the analysis data.

In an embodiment, the display unit 129 may be not essential for the image capture device 120. The image capture device 120 could transmit the analysis data or the sampling image signal to another electrical apparatus with a built-in display unit by the transmission unit 127. The transmission unit 127 may be a wireless transmission unit, such as Bluetooth unit or Wi-Fi unit.

In an embodiment, the microscope module 100 may comprise a housing 10, a lens element 11, a sampling assembly (13,15), and a light guide element 17. In an embodiment, the microscope module 100 may comprise a light source element 19 alternatively. The lens element 11 may be mounted on housing 10. The sampling assembly, the light guide element 17, and the light source element 19 may be accommodated in the housing 10.

In an embodiment, the housing 10 may have a head plate 101 and a lateral structure 103. The lateral structure 103 is connected to and surrounds the head plate 101, in order to define a cavity S₀. The head plate 101 is equipped with a first hole P₁ disposed at the center thereon. The lens element 11 is mounted on the first hole P₁ and coaxially aligned with the lens module 121. A magnification ratio of the lens element 11 may be about between 0.1 and 2, and a field of view (FOV) of the lens element 11 may be about between 0.1 mm² to 100 mm². The number of magnification ratio is not limited to the above-mention configuration. In an embodiment, the lens element 11 and the lens module 121 may be cooperated with each other for focusing and enlarging an image of a specimen in the sampling assembly. In other embodiment, the lens element 11 and the lens module 121 may be arranged as another lens module.

In an embodiment, the sampling assembly could be applied to sample a specimen, such as nature matter, animal body fluid cells or plant fluid cells. The sampling assembly is accommodated in the cavity S₀. The sampling assembly may comprise a cover body 13 and a base body 15. In another embodiment, the sampling assembly may comprise a base body 15 and a light guide element 17 connected with each other. The cover body 13 has a first top plate 131 and a first anchoring structure 133. The anchoring structure 133 may be at least one side plate or a surrounding wall. In an embodiment, the side plates may be spaced apart from one another. The first top plate 131 is spaced apart from or contacted with the lens element 11. The first anchoring structure 133 is connected to and surrounds the first top plate 131, in order to define a first space S₁. The base body 15 has a second top plate 151 and a second anchoring structure 153. The second anchoring structure 153 is connected to and surrounds the second top plate 151, in order to define a second space S₂. The base body 15 is accommodated in the first space S₁. The second top plate 151 is spaced apart from or contacted with the first top plate 131, in order to define a holding space for storing the specimen. A distance between the first top plate 131 and the second top plate 151 may be between 0.1 μm to 500 μm. A thickness of the first top plate 131 may be between 100 μm to 1000 μm.

In an embodiment, the light source element 19 could be applied to provide a light source to illustrate the specimen in the sampling assembly. The light guide element 17 could be applied to conduct the light source to the second top plate 151. The light guide element 17 is mounted in the second space S₂. The light source element 19 is connected to the light guide element 17. In an embodiment, the sampling assembly (13, 15), the light guide element 17, and the light source element 19 are coaxially aligned with one another.

In an embodiment, a cross-section of the first anchoring structure 133 may be in a first truncated shape, and a cross-section of the second anchoring structure 153 may be in a second truncated shape as show in FIG. 1A. The shapes of the first anchoring structure 133 and the second anchoring structure 153 are not limited in these configurations, and may be in cylindrical shape. The first top plate 131 and the second top plate 151 may be in circular or rectangular shape. The first top plate 131 has an inside surface 1311 and an outside surface 1313 opposite to the inside surface 1311. The first anchoring structure 133 has an inside surface 1331 and an outside surface 1333 opposite to the inside surface 1331. The second top plate 151 has an inside surface 1511 and an outside surface 1513 opposite to the inside surface 1511. The second anchoring structure 153 has an inside surface 1531 and an outside surface 1533 opposite to the inside surface 1531. In an embodiment, a shape of the first top plate 131 or the second top plate 151 may be in a circular, triangle, or rectangle shape.

In an embodiment, the inside surface 1331 of the first anchoring structure 133 may have an alignment structure 1334. The alignment structure 1334 could guide the base body 15 to be coaxially aligned with the cover body 13, and guide the base body 15 to be positioned spaced apart from or partially contacted with the cover body 13. Particularly, the outside surface 1533 of the second anchoring structure 153 is spaced apart from the inside surface 1331 of the first anchoring structure 133 for directing a superfluity of the specimen. In an embodiment, the alignment structure 1334 may include a plurality of elongated sinks along the inside surface 1331 of the first anchoring structure 133. In other embodiment, the alignment structure 1334 may include an annular rim. The alignment structure 1335 may contact to the forward end of the second anchoring structure 153.

The sampling assembly further comprising an engagement structure between the cover body 13 and base body 15. In an embodiment, the inside surface 1331 of the first anchoring structure 133 may have a first engagement part 1332, and the outside surface 1533 of the second anchoring structure 153 may have a second engagement part 1532. The first engagement part 1332 and the second engagement part 1532 may be a one-time or a one-way locking mechanism. In an embodiment, the first engagement part 1332 and the second engagement part 1532 are a notch and a projection. In other embodiment, the first engagement part 1332 and the second engagement part 1532 are a male screw thread and a female screw thread.

In an embodiment, the first anchoring structure 133 has a top end and a bottom end, in which the top end may be connected to the first top plate 131, and the bottom end may have a first extending anchoring structure 1335. The extending direction of the first extending anchoring structure 1335 is perpendicular to the first top plate 131. Similarly, the second anchoring structure 153 has a top end and a bottom end, in which the top end may be connected to the second top plate 151, and the bottom end may have a second extending anchoring structure 1535. The first extending anchoring structure 1335 may be contacted with the second extending anchoring structure 1535. Particularly, the first space S₁ may be sealed via the contact of the first extending anchoring structure 1335 and the second extending anchoring structure 1535. In an embodiment, the first engagement part 1332 may be arranged on the first extending anchoring structure 1335, and the second engagement part 1532 may be arranged on the second extending anchoring structure 1535.

FIG. 1B depicts a schematic diagram illustrating a sampling assembly, in accordance with an example embodiment of the present disclosure. In order to prepare the sample in the sampling assembly, a container 18 stored a specimen T, and separated cover body 13 and base body 15 are prepared. The second extending anchoring structure 1535 could be easily held by a user, and the second top plate 151 could be dipped into the specimen T. Some of specimen T could be absorbed on the outside surface 1513 of the second top plate 151 because of surface tension of fluid sample T₁. The cover body 13 and the base body 15 could be folded for sealing the first space S₁ and preventing from unwanted contamination to a sample T₁ in the sampling assembly or leaking.

Return to FIG. 1A, the light guide element 17 may include a hollow rod case 170 having a third space S₃. The light source element 19 may include a base 190, an illumination source 191, a power provider 193, and a switch unit 195. The illumination source 191 may be mounted on the base 190 and accommodated in the third space S₃. In one embodiment, the hollow rod case 170 has a forward end 171 and a backward end 173. The forward end 171 has a second hole P₂, which is aligned with the first hole P₁. The backward end 173 may surround the illumination source 191 and be connected to the base 190.

In an embodiment, the illumination source 191 may comprise a visible light source, an UV light source, or a fluorescence excitation source. The light guide element 17 cooperated with the light source element 19 may be configured to implement a contrast mechanism selected from brightfield illumination, darkfield illumination, and phase contrast. A distance between the illumination source 191 and the second top plate 151 may be between 0.1 cm and 10 cm. The power provider 193 may be mounted in the base 190 and comprise a battery or a solar cell. The switch unit 195 may be mounted on the base 190 and comprise a button or a touch switch unit. The base 190 may have a first locking structure 197 engaged with a second locking structure 107 of the housing 10.

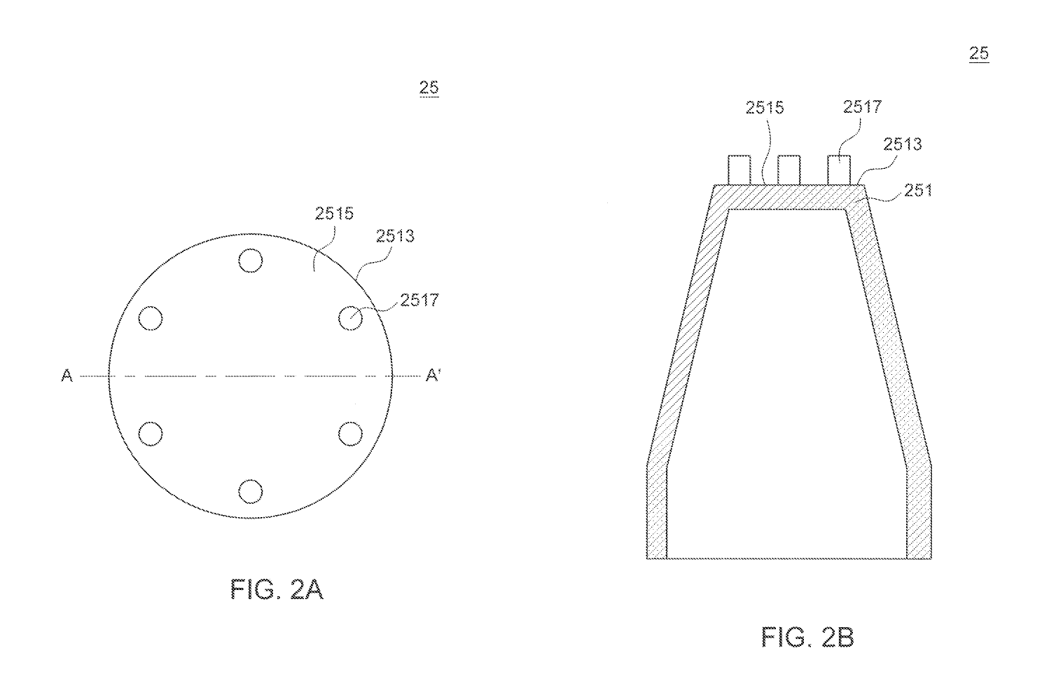

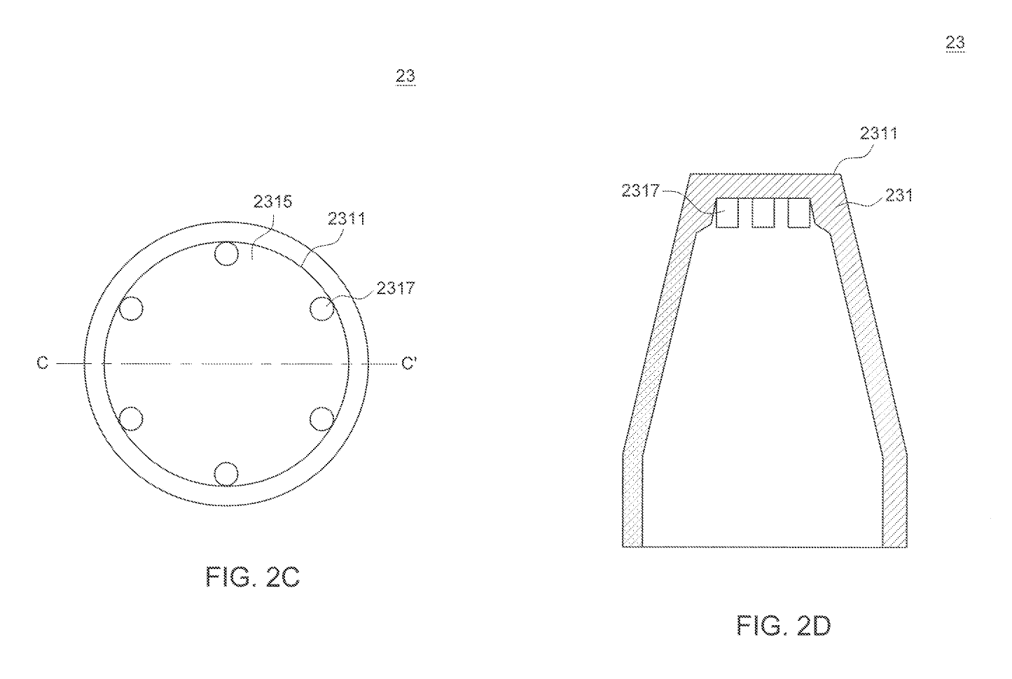

FIG. 2A depicts a top view of a base body of a sampling assembly and FIG. 2B depicts a section view along A-A′ axis of a base body of a sampling assembly, in accordance with an example embodiment of the present disclosure. The outside surface 2513 of the second top plate 251 of the base body 25 may include a planar area 2515 and a plurality of bumps 2517. The bumps 2517 may be contacted to the inside surface of the cover body, and thereby the sample would be protected in the sampling assembly. The bumps 2517 may be disposed in a peripheral of the outside surface 2513 and surrounding the planar area 2515.

FIG. 2C depicts a bottom view of a cover body of a sampling assembly and FIG. 2D depicts a section view along C-C′ axis of a cover body of a sampling assembly, in accordance with an example embodiment of the present disclosure. The inside surface 2311 of the first top plate 231 of the cover body 23 may include a planar area 2315 and a plurality of bumps 2317. The bumps 2317 may be contacted to the outside surface of the base body, and thereby the sample would be protected in the sampling assembly. The bumps 2317 may be disposed in a peripheral of the inside surface 2311 and surrounding the planar area 2315.

In an embodiment, an area of the planar area 2515 or 2315 may be about between 50 mm² and 400 mm². A thickness of the bumps 2517 or 2317 is about between 0.1 μm and 500 μm. A size, such as diameter or width, of the bumps 2517 or 2317 is about between 0.1 mm and 10 mm.

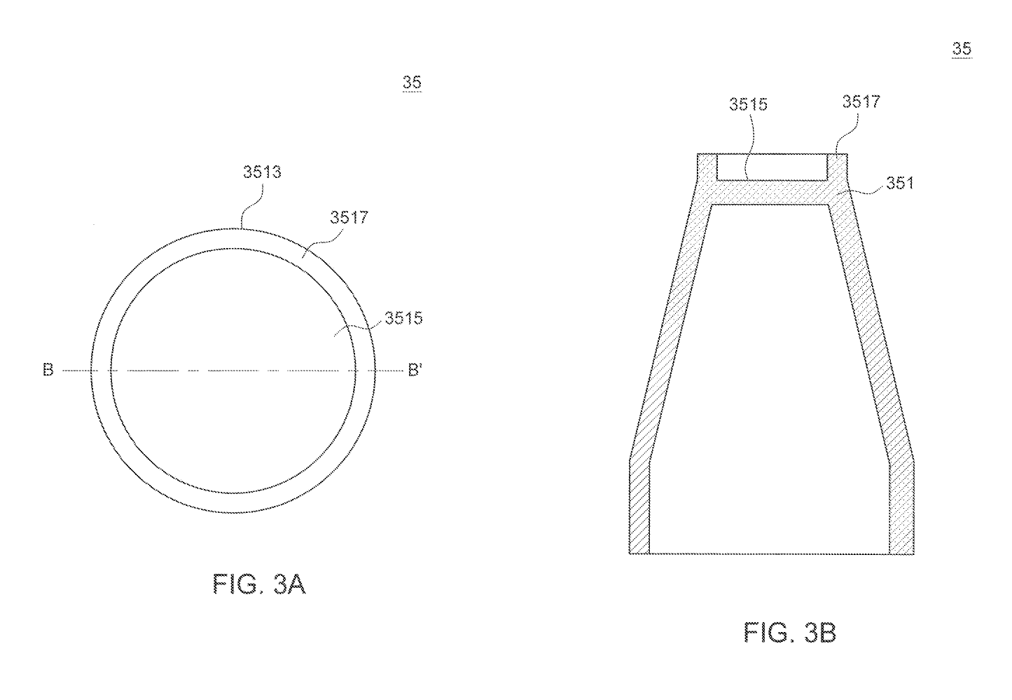

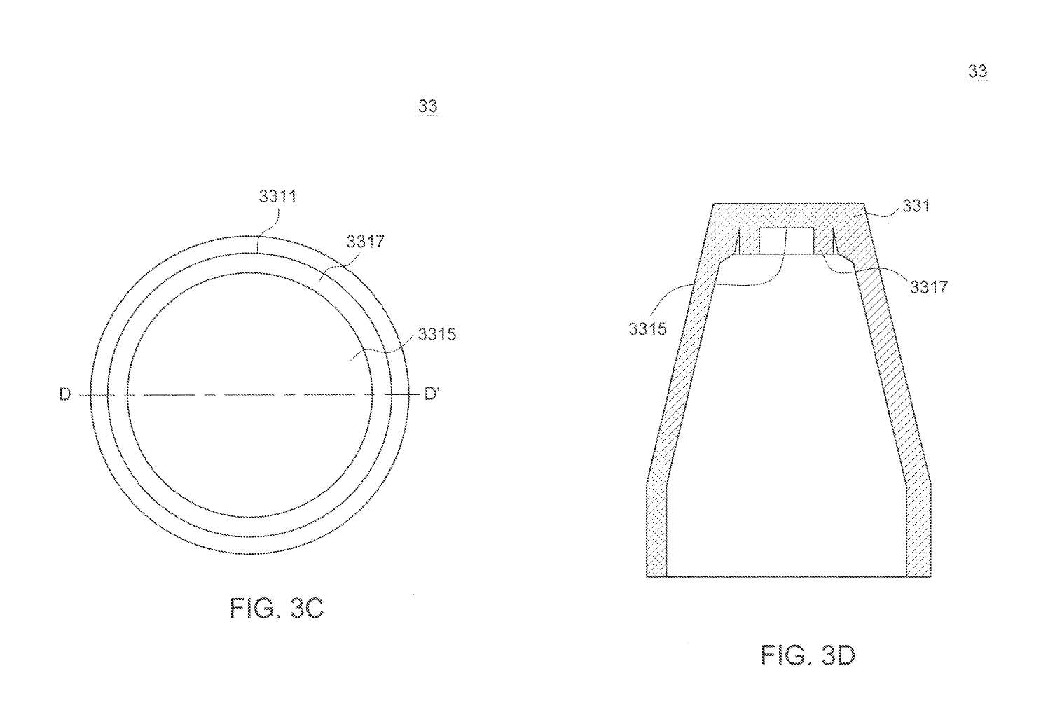

FIG. 3A depicts a top view of a base body of a sampling assembly, FIG. 3B depicts a section view along B-B′ of a base body of a sampling assembly, in accordance with an example embodiment of the present disclosure. The outside surface 3513 of the second top plate 351 of the base body 35 may include a planar area 3515 and a convex ring 3517. The convex ring 3517 may be contacted to the inside surface of the cover body, and thereby the sample would be protected in the sampling assembly. The convex ring 3517 may be disposed in a peripheral of the outside surface 3513 and surrounding the planar area 3515. Further, the convex ring 3517 could determine the amount of the sample and prevent from leaking of the sample.

FIG. 3C depicts a bottom view of a cover body of a sampling assembly, FIG. 3D depicts a section view along D-D′ axis of a cover body of a sampling assembly, in accordance with an example embodiment of the present disclosure. The inside surface 3311 of the first top plate 331 of the cover body 33 may include a planar area 3315 and a convex ring 3317. The convex ring 3317 may be contacted to the outside surface of the base body, and thereby the sample would be protected in the sampling assembly. The convex ring 3317 may be disposed in a peripheral of the inside surface 3311 and surrounding the planar area 3315. Further, the convex ring 3317 could determine the amount of the sample and prevent from leaking of the sample.

In an embodiment, an area of the planar area 3515 or 3315 may be about between 50 mm² and 400 mm². A thickness of the convex ring 3517 or 3317 is about between 0.1 μm and 500 μm. A size, such as width, of convex ring 3517 or 3317 is about between 0.1 mm and 10 mm.

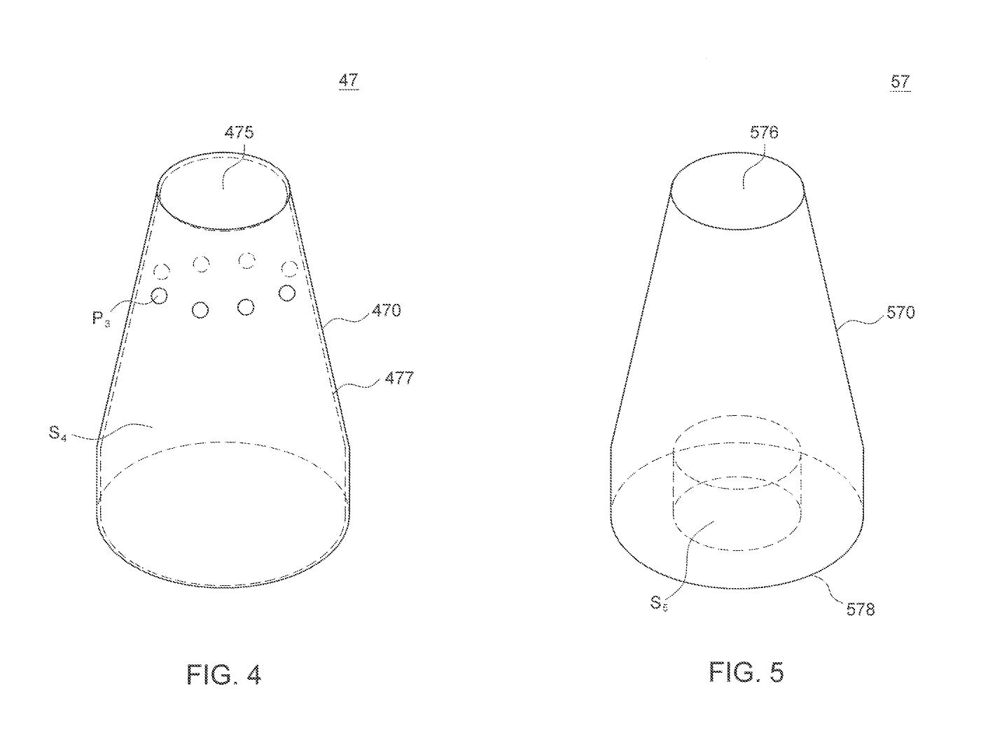

FIG. 4 depicts a schematic diagram illustrating a light guide element of a microscope module, in accordance with an example embodiment of the present disclosure. The light guide element 47 may include a hollow rod case 470. The hollow rod case may have a third top plate 475 and a surrounding wall 477. The third top plate 475 may be spaced apart from or contacted with the second top plate of the base body. The surrounding wall 477 may surround the third top plate 475, in order to define a fourth space S₄. In an embodiment, the surrounding wall 477 may have a plurality of third holes P₃ thereon. When the illumination source of the light source element is mounted in the fourth space S₄, the light source element could provide lateral emission of light for darkfield illumination. In an embodiment, a cross-section of the hollow rod case 470 may be in a truncated cone shape or cylindrical shape.

FIG. 5 depicts schematic diagram illustrating a light guide element of a microscope module, in accordance with an example embodiment of the present disclosure. The light guide element 57 may include a solid rod body 570 having a top 576 and a bottom 578. The top 576 may be spaced apart from or contacted with the second top plate of the base body. The bottom 578 has a recess S₅, in order to accommodate the illumination source.

The above-mention cover body, base bodies, and light guide elements may be made by plastic injection molding process. The material of cover body, base bodies, and light guide may be glass, PS, PMMA, PC, or COC. Therefore, the cost of manufacturing the sampling assembly and the light guide element is low.

An advantage of the sampling assembly, the microscope module, and the microscope apparatus described herein are improved the sampling process, the manufacturing cost, and analysis process. By using the cover body and the base body folded with each other, the present assembly can reduce an occurrence of leaking or contamination of the sample.

Realizations in accordance with the present disclosure have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Field of the Disclosure,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A sampling assembly for sampling a specimen, comprising:
a cover body having a first top plate and a first anchoring structure connected to the first top plate; and
a base body placed in the cover body having a second top plate and a second anchoring structure connected to the second top plate, wherein the second top plate faces the first top plate and includes a holding space for the specimen.

2. The assembly according to claim 1, wherein the first anchoring structure comprises a surrounding wall.

3. The assembly according to claim 1, wherein the first anchoring structure comprises at least one side plate.

4. The assembly according to claim 1, wherein the second anchoring structure comprises a surrounding wall.

5. The assembly according to claim 1, wherein the second anchoring structure comprises at least one side plate.

6. The assembly according to claim 1, further comprising a plurality of bumps between the first top plate and the second top plate.

7. The assembly according to claim 6, wherein the first top plate has an inside surface and an outside surface opposite to the inside surface, and the bumps are disposed on the inside surface.

8. The assembly according to claim 6, wherein the second top plate has an inside surface and an outside surface opposite to the inside surface, and the bumps are disposed on the outside surface.

9. The assembly according to claim 6, wherein a thickness of the bumps is between 0.1 μm and 500 μm.

10. The assembly according to claim 1, further comprising a convex ring between the first top plate and the second top plate.

11. The assembly according to claim 10, wherein the first top plate has an inside surface and an outside surface opposite to the inside surface, and the convex ring is disposed on the inside surface.

12. The assembly according to claim 10, wherein the second top plate has an inside surface and an outside surface opposite to the inside surface, and the convex ring is disposed on the outside surface.

13. The assembly according to claim 10, wherein a thickness of the convex ring is between 0.1 μm and 500 μm.

14. The assembly according to claim 1, wherein the first anchoring structure has an inside surface and an outside surface opposite to the inside surface, and the inside surface has an alignment structure for guiding the base body aligned with the cover body.

15. The assembly according to claim 1, further comprising an engagement structure between the cover body and the base body.

16. The assembly according to claim 1, wherein a thickness of the first top plate is between 100 μm and 1000 μm.

17. A microscope module applied to provide a sampling image, comprising:
a housing having a head plate, a lateral structure connected to the head plate, and a cavity between the head plate and the lateral structure, wherein the head plate has a first hole;
a lens element mounted on the first hole; and
a sampling assembly as claimed in claim 1 accommodated in the cavity, wherein a first top plate of the sampling assembly faces the lens element.

18. The module according to claim 17, further comprising a light guide element connected to the sampling assembly.

19. The module according to claim 18, further comprising a light source element connected to the light guide element.

20. The module according to claim 18, wherein the light guide element includes a hollow rod case.

21. The module according to claim 20, wherein the hollow rod case has a forward end and a backward end, the forward end has a second hole faces the second top plate of the sampling assembly and aligned with the first hole, and the backward end faces the light source element.

22. The module according to claim 20, wherein the hollow rod case includes a third top plate and a surrounding wall connected to the third top plate, the third top plate faces a second top plate of the sampling assembly, and the surrounding wall has a plurality of third holes.

23. The module according to claim 18, wherein the light guide element includes a solid rod body having a top and bottom, the top faces a second top plate of the sampling assembly, the bottom has a recess, and the light source element is mounted in the recess.

24. The module according to claim 17, wherein a magnification ratio of the lens element is between 0.1 and 2.

25. The module according to claim 17, wherein a field of view of the lens element is between 0.1 mm² and 100 mm².

26. A microscope apparatus, comprising:
a microscope module as claimed in claim 18; and
an image capture device including:
a lens module aligned with and cooperated with a lens element of the microscope module to obtain a sampling image;
an image sensor configured to capture the sampling image from the lens module; and
a processing unit electrically connected to the image sensor.

27. The apparatus according to claim 26, wherein the processing unit is configured to perform an image process on the sampling image and generate an analysis data.

28. The apparatus according to claim 27, further comprising a transmission unit electrically connected to the processing unit and configured to output the analysis data.

29. The apparatus according to claim 26, further comprising a transmission unit electrically connected to the processing unit and configured to output the sampling image.

30. A sampling assembly for sampling a specimen, comprising:
a base body having a top plate and a anchoring structure connected to the top plate; and
a light guide element connected to the anchoring structure for guiding a light to the top plate.

31. The assembly according to claim 30, wherein the anchoring structure comprises a surrounding wall.

32. The assembly according to claim 30, wherein the anchoring structure comprises at least one side plate.

33. The assembly according to claim 30, further comprising a plurality of bumps, wherein the top plate has an inside surface and an outside surface opposite to the inside surface, and the bumps are disposed on the outside surface.

34. The assembly according to claim 30, further comprising a convex ring, wherein the top plate has an inside surface and an outside surface opposite to the inside surface, and the convex ring is disposed on the outside surface.

35. The assembly according to claim 30, wherein the light guide element includes a hollow rod case.

36. The assembly according to claim 30, wherein the light guide element includes a solid rod body.
